(19) United States
(12) Patent Application Publication
(10) Pub. No.: US 2026/0269249 A1
(43) Pub. Date: Sep. 10, 2026

(54) Secondary Battery

(71) Applicant: Nippon Telegraph and Telephone Corporation, Tokyo (JP)

(72) Inventors: Shuhei Sakamoto, Musashino-shi, Tokyo (JP); Masaya Nohara, Musashino-shi, Tokyo (JP); Sho Okubo, Musashino-shi, Tokyo (JP); Hiroaki Taguchi, Musashino-shi, Tokyo (JP); Takeshi Komatsu, Musashino-shi, Tokyo (JP)

(21) Appl. No.: 18/869,459

(22) PCT Filed: May 26, 2022
(86) PCT No.: PCT/JP2022/021637

§ 371 Date: Nov. 26, 2024

(51) Int. Cl. H01M 4/60; H01M 4/66; H01M 4/74; H01M 10/0525; H01M 50/109

(52) U.S. Cl. CPC H01M 4/60; H01M 4/661; H01M 4/74; H01M 10/0525; H01M 50/109

(57) ABSTRACT

A secondary battery includes a positive electrode containing an N,N′-mono-8-quinolyl-o-phenylene-Ni complex and 2,5-dimethoxy-1,4-benzoquinone, a negative electrode containing magnesium, sodium, or calcium, and an electrolyte disposed between the positive electrode and the negative electrode.

### TECHNICAL FIELD

The present invention relates to a secondary battery.

### BACKGROUND ART

As disposable primary batteries and rechargeable secondary batteries, alkaline batteries, manganese batteries, high-performance coin-type lithium secondary batteries, nickel-cadmium batteries, nickel-metal hydride batteries, lithium ion batteries, and the like have been widely used in small devices, sensors, mobile devices, and the like in the related art.

Along with recent development of the Internet of Things (IoT), scattered type sensors which are to be placed and used at various places in nature such as soil and forests have also been developed. In addition, an air battery having a low environmental impact has been studied (Patent Literature 1).

### CITATION LIST

### Patent Literature

Patent Literature 1: JP 6711915 B1

### SUMMARY OF INVENTION

### Technical Problem

Batteries in the related art employ materials having a high environmental impact such as lead compounds, cadmium compounds, manganese compounds, nickel compounds, and fluorine compounds, which requires a special treatment at the time of disposal. Such batteries in the related art should not be disposed of as general waste and are not suitable as products to be mounted on scattered type sensors. Therefore, there have been demands for batteries composed of materials having a low environmental impact.

The battery principle of Patent Literature 1 is that of an air battery. An air battery uses oxygen in the air as a positive electrode active material and indispensably requires an air inlet. The air battery is not suitable for long-term storage due to a disadvantage that an electrolytic solution volatilizes from the air inlet. Therefore, there is a demand for a new secondary battery that needs no oxygen for a positive electrode active material and has a low environmental impact.

Secondary batteries are reusable, enabling both charge and discharge. Accordingly, it is possible to reduce the number of batteries to be disposed of as compared with primary batteries having the same capacity and the same voltage, and secondary batteries have a low environmental impact.

The present invention has been made in view of the circumstances, and an object of the present invention is to provide a secondary battery having a low environmental impact and storable for a long period of time.

### Solution to Problem

A secondary battery according to an aspect of the present invention includes a positive electrode containing an N,N′-mono-8-quinolyl-o-phenylene-Ni complex and 2,5-dimethoxy-1,4-benzoquinone, a negative electrode containing magnesium, sodium, or calcium, and an electrolyte disposed between the positive electrode and the negative electrode.

### Advantageous Effects of Invention

According to the present invention, there is provided a secondary battery having a low environmental impact and storable for a long period of time.

### BRIEF DESCRIPTION OF DRAWINGS

FIG. 1 is a basic schematic view of a secondary battery according to this embodiment.

FIG. 2 is a schematic cross-sectional view illustrating a structure of a coin-type secondary battery.

### DESCRIPTION OF EMBODIMENTS

Hereinafter, an embodiment of the present invention will be described with reference to the drawings.

### [Configuration of Secondary Battery]

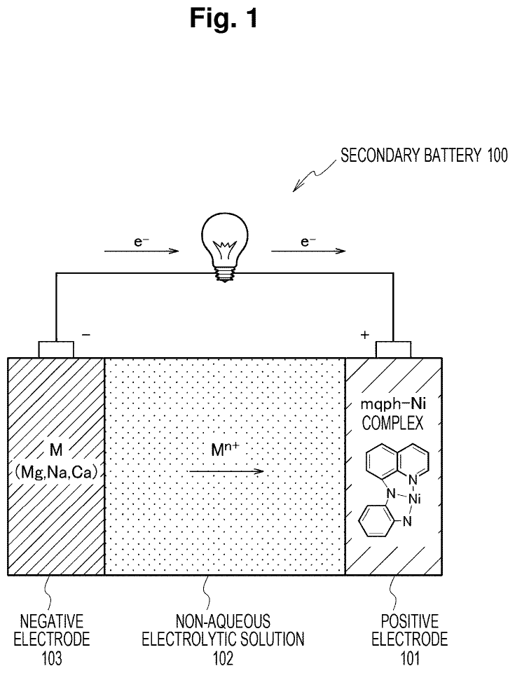

FIG. 1 is a view illustrating a configuration of a secondary battery according to an embodiment of the present invention. This secondary battery includes a positive electrode 101 containing an N,N′-mono-8-quinolyl-o-phenylene-Ni complex (hereinafter referred to as “mqph-Ni complex”) and 2,5-dimethoxy-1,4-benzoquinone (hereinafter referred to as) negative electrode 103 containing magnesium, sodium, or calcium, and an electrolyte 102 disposed between the positive electrode 101 and the negative electrode 103.

The positive electrode 101 contains the mqph-Ni complex as a redox mediator and DMBQ as a positive electrode active material. As the electrolyte 102, a non-aqueous electrolytic solution 102 is preferably used. In this embodiment, for example, the non-aqueous electrolytic solution 102 is used as the electrolyte 102, but the present invention is not limited thereto.

This embodiment will now be described, but note that the present invention is not limited to this embodiment unless the gist of the invention is changed.

Formula (1) represents charging and discharging reactions in the negative electrode 103, and Formula (2) represents charging and discharging reactions in the positive electrode 101.

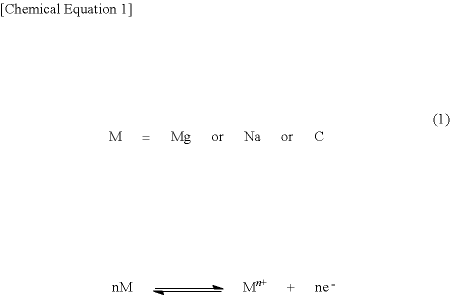

(When Mg or Ca is used, n=2, and when Na is used, n=1)

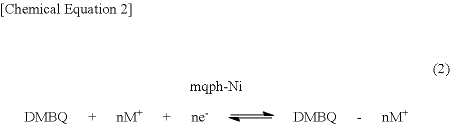

Bonding between DMBQ and a metal ion contained in the positive electrode 101 causes a discharging reaction to proceed. A charging reaction proceeds in the opposite direction. At this time, the mqph-Ni complex contained in the positive electrode 101 plays a role in electron transfer, thereby promoting the charging and discharging reactions.

The mqph-Ni complex contained in the positive electrode 101 may be in a polymer state. The polymer state refers to a molecule that maintains the redox activity of the mqph-Ni complex and has an increased molecular weight. A known method is applicable in polymerizing the mqph-Ni complex.

In addition, using a polymer compound, the positive electrode active material (DMBQ herein) contained in the positive electrode 101 is less likely to be dissolved in an electrolytic solution by an electrochemical reaction and anticipated to have excellent stability with little deterioration over a long period of time. The molecular weight of the polymer compound is preferably 10,000 or more, and more preferably 100,000 or more.

The operating voltage (theoretical electromotive force) is about 2.0 V when DMBQ is used as the positive electrode active material and Mg is used as a negative electrode active material and about 2.2 V when DMBQ is used as the positive electrode active material and Na or Ca is used as the negative electrode active material.

Employing DMBQ for the positive electrode active material, magnesium, sodium, or calcium for the negative electrode active material, and a non-aqueous electrolytic solution for the electrolyte, the secondary battery of this embodiment is anticipated as a battery having a low environmental impact. In addition, employing DMBQ for the positive electrode active material enables the secondary battery of this embodiment to be used as a sealed battery requiring no air inlet which is necessary for an air battery. Accordingly, the secondary battery of this embodiment is storable for a long period of time without causing volatilization of the electrolytic solution from an air inlet.

The positive electrode 101 contains the positive electrode active material and a conductive aid as constituent elements. The negative electrode 103 contains the negative electrode active material and a conductive aid as constituent elements.

Each constituent element of the secondary battery will now be described.

### (1) Positive Electrode

The positive electrode of this embodiment contains at least the mqph-Ni complex as the redox mediator and the positive electrode active material n a conductive aid or a current collector (to be described) as needed. It is preferable to form the positive electrode on a porous current collector containing at least one selected from the group consisting of aluminum, copper, and iron or on a non-woven fabric current collector containing carbon without a binder.

It is also preferable to form the positive electrode on a monolith having a three-dimensional network structure with a plurality of nanostructures being integrated by a noncovalent bond. A monolith obtains a three-dimensional network structure through ramification of a plurality of nanostructures integrated by a noncovalent bond.

Specific examples of the binder include polytetrafluoroethylene (PTFE), polyvinylidene fluoride (PVDF), styrene butadiene rubber, ethylene propylene diene rubber, and natural rubber.

In this embodiment, the positive electrode is made to contain the mqph-Ni complex as the redox mediator, whereby the positive electrode is highly active to charging and discharging reactions.

In addition, forming the positive electrode on the porous current collector, on the non-woven fabric current collector containing carbon, or on the monolith makes it possible to sufficiently draw out a potential of the mqph-Ni complex as the redox mediator and a potential of DMBQ as the positive electrode active material.

### (1-1) Positive Electrode Active Material

The positive electrode active material of this embodiment contains at least DMBQ. Since DMBQ is free of rare metals, it has a low environmental impact and is inexpensive.

The positive electrode active material is preferably in a polymer state. This is because a positive electrode active material with a small molecular weight is easily dissolved in an electrolytic solution. The positive electrode active material preferably has a molecular weight of 10,000 or more, and more preferably 100,000 or more.

DMBQ is available, for example, as a commercial product or by a known synthesis.

### (1-2) Preparation of Positive Electrode Using Conductive Aid

In this embodiment, the positive electrode may contain a conductive aid. As the conductive aid, for example, carbon is used. Specific examples of the conductive aid include carbon black such as Ketjen black and acetylene black, activated carbon, graphite, and carbon fibers.

In order to sufficiently ensure a reaction site in the positive electrode, carbon having a small particle size is suitable. Specifically, carbon having a particle size of 1 μm or less is desirable. Such carbon is available, for example, as a commercial product or by a known synthesis.

### (1-3) Preparation of Positive Electrode Using Redox Mediator

In this embodiment, the positive electrode contains at least the mqph-Ni complex as the positive electrode redox mediator. The positive electrode preferably contains the mqph-Ni complex in an amount of 10 wt % to 60 wt %, and more preferably 40 wt %.

The mqph-Ni complex is available, for example, by a known synthesis.

The positive electrode is prepared by mixing DMBQ powder as the positive electrode active material, the conductive aid, the redox mediator, and the binder as needed and by supporting the resulting mixture with a conductive material.

### (1-4) Preparation of Positive Electrode Using Current Collector

The positive electrode is formed on the porous current collector containing at least one selected from the group consisting of aluminum, copper, and iron or on the non-woven fabric current collector containing carbon. The positive electrode does not necessarily contain the binder. Specifically, the positive electrode active material may be directly supported on such a current collector. The expression “directly supported” represents that the positive electrode active material is finely and three-dimensionally bonded to the current collector. This configuration enhances the conductivity. In a case where the positive electrode active material is not directly supported, for example, placing a disk of the current collector on a disk of the positive electrode active material brings surfaces of the current collector and the positive electrode active material into contact with each other, which decreases the conductivity as compared with a case where the positive electrode active material is directly supported. The porous current collector and the non-woven fabric current collector are available as, for example, commercial products.

Alternatively, the positive electrode is formed on the monolith having a three-dimensional network structure with a plurality of nanostructures being integrated by a noncovalent bond. The positive electrode does not necessarily contain the binder. Specifically, the positive electrode active material may be supported on the monolith. The monolith has a stretchable integral structure in which bonding portions between the nanostructures are deformable. The monolith preferably has, for example, an average pore size of 0.1 μm to 50 μm.

The nanostructures are, for example, nanosheets or nanofibers and have conductivity. An example of the nanosheets includes graphene. Graphene-based nanofibers are fibrous substances having a diameter of 1 nm to 1 μm and a length 100-fold the diameter or longer. Examples of such nanofibers include iron oxides, manganese oxides, silicon, and carbonized cellulose. The carbonized cellulose is manufactured by producing a gel in which cellulose nanofibers are dispersed and heating the gel in an inert gas atmosphere to carbonize the gel.

The monolith is manufactured by drying, in a vacuum, a frozen body obtained through freezing of a sol or gel in which nanostructures such as nanosheets or nanofibers are dispersed.

Specific examples of a dispersion medium of the sol include aqueous media such as water and organic media such as carboxylic acid, methanol, ethanol, propanol, n-butanol, isobutanol, n-butylamine, dodecane, unsaturated fatty acid, ethylene glycol, heptane, hexadecane, isoamyl alcohol, octanol, isopropanol, acetone, and glycerin. Two or more kinds of these materials may be mixed.

Specific examples of a dispersion medium of the gel include aqueous media such as water (H₂O) and organic media such as carboxylic acid, methanol (CH₃OH), ethanol (C₂H₅OH), propanol (C₃H₇OH), n-butanol, isobutanol, n-butylamine, dodecane, unsaturated fatty acid, ethylene glycol, heptane, hexadecane, isoamyl alcohol, octanol, isopropanol, acetone, and glycerin. Two or more kinds of these materials may be mixed.

The degree of vacuum in the drying varies with the dispersion medium to be used but is not limited to any specific value as long as the dispersion medium sublimates. For example, in a case where water is used as the dispersion medium, the degree of vacuum needs to be set in such a manner that the pressure becomes 0.06 MPa or lower. However, since heat is carried away as latent heat of sublimation, the drying takes time. For this reason, the degree of vacuum is preferably 1.0×10⁻⁶ to 1.0×10⁻² Pa. Furthermore, heat may be applied from a heater or the like during the drying.

This monolith can have a high-specific surface area than a commercially available conductive porous body or non-woven fabric current collector. The specific surface area of the monolith is preferably 200 m²/g or more. The monolith is also referred to as a copolymer.

In order to support the positive electrode active material on the porous current collector, the non-woven fabric current collector, and the monolith, the following methods are employable. For example, there are physical methods such as vapor deposition, sputtering, and a planetary ball mill. Alternatively, the porous current collector, the non-woven fabric current collector, and the monolith may be immersed in a liquid in which the positive electrode active material is dissolved, and then, dried. Furthermore, there are chemical methods such as sol-gel method and other known methods.

In order to simply form a high-quality positive electrode, the positive electrode active material is preferably supported by impregnating a liquid in which the positive electrode active material is dissolved with the porous current collector, the non-woven fabric current collector, and the monolith and by drying them. Applying cold pressing or hot pressing to the dried electrode (positive electrode) enhances the strength of the electrode and enables the positive electrode to have better stability.

Specific examples of a solvent for dissolving the positive electrode active material include aqueous solvents such as water and organic solvents such as tetrahydrofuran (THF), tetrahydroplan (THP), dioxane, diethyl ether, N-methyl-2 pyrrolidone (NMP), hexamethylphosphoric acid amide (HMPA), tetramethylurea (TMU), dimethylacetamide (DMAC), dimethylformaldehyde (DMF), dimethyl sulfoxide (DMSO), m-cresol, and chloroform. Two or more kinds of these materials may be mixed.

In the secondary battery of this embodiment, since a reaction expressed by Formula (2) proceeds on the surface of the positive electrode, it is preferable to generate a large number of reaction sites inside the positive electrode. In a case where the positive electrode is molded using the conductive aid and the binder, an increase in specific surface area decreases the binding strength of the conductive aid and deteriorates the structure, whereby the positive electrode has difficulty in discharging stably and decreases in discharge capacity. Since the binder is an insulating substance, a large amount of the binder decreases in conductivity, leading to deterioration of battery performance (discharge voltage, discharge capacity). In addition, using Ketjen black powder as the conductive aid makes it difficult to increase the specific surface area from the aspect of the binding strength.

In contrast, the positive electrode molded using the porous body current collector, the non-woven fabric current collector, or the monolith secures a large quantity of reaction sites and solves the aforementioned problems, thereby increasing the discharge capacity. In particular, the monolith has a high bulk density and supports a larger quantity of the positive electrode active material, thereby increasing the efficiency of the battery.

In this manner, the positive electrode is made to contain the mqph-Ni complex as the positive electrode redox mediator, whereby the positive electrode is highly active to charging and discharging reactions. In addition, forming the positive electrode on the porous current collector, on the non-woven fabric current collector containing carbon, or on the monolith makes it possible to sufficiently draw out a potential of the mqph-Ni complex as the positive electrode redox mediator and a potential of DMBQ as the positive electrode active material.

### (2) Negative Electrode

The secondary battery of this embodiment contains at least magnesium (Mg), sodium (Na), or calcium (Ca) as the negative electrode active material. The negative electrode active material will do as long as it contains magnesium (Mg), sodium (Na), or calcium (Ca) as a main component and may also be an alloy containing at least one component selected from the group consisting of lithium (Li), zinc (Zn), aluminum (Al), manganese (Mn), iron (Fe), tin (Sn), and carbon (C).

### (3) Non-Aqueous Electrolytic Solution (Electrolyte)

The secondary battery of this embodiment contains the non-aqueous electrolytic solution. This non-aqueous electrolytic solution is a solution containing an electrolyte that allows magnesium ions (Mg²⁺), sodium ions (Na⁺), or calcium ions (Ca²⁺) to move.

The non-aqueous electrolytic solution contains an organic solvent as a main solvent and may also contain, for example, water other than the organic solvent. As the non-aqueous electrolytic solution, it is possible to use an electrolytic solution obtained by dissolving a magnesium salt, a sodium salt, or a calcium salt in at least one organic solvent selected from the group consisting of carbonate ester-based solvents such as dimethyl carbonate (DMC), methyl ethyl carbonate (MEC), methyl propyl carbonate (MPC), methyl isopropyl carbonate (MIPC), methyl butyl carbonate (MBC), diethyl carbonate (DEC), ethyl propyl carbonate (EPC), ethyl isopropyl carbonate (EIPC), ethyl butyl carbonate (EBC), dipropyl carbonate (DPC), diisopropyl carbonate (DIPC), dibutyl carbonate (DBC), ethylene carbonate (EC), propylene carbonate (PC), and 1,2-butylene carbonate (1,2-BC), ether-based solvents such as 1,2-dimethoxyethane (DME) and tetraethylene glycol dimethyl ether (TEGDME), lactone-based solvents such as γ-butyrolactone (GBL), and sulfoxide-based solvents such as dimethyl sulfoxide (DMSO).

The magnesium salt, the sodium salt, and the calcium salt are respectively represented by Mg—X₂, Na—X, and Ca—X₂ where X is, for example, Cl, Br, I, BF₄, PF₆, CF₃SO₃, ClO₄, CF₃CO₂, ASF₆, SbF₆, AlCl₄, N(CF₃SO₂)₂, N(CF₃CF₂SO₂)₂, PF₃(C₂F₅)₃, N(FSO₂)₂, N(FSO₂) (CF₃SO₂), N(CF₃CF₂SO₂)₂, N(C₂F₆S₂O₄), N(C₃F₆S₂O₄), N(CN)₂, N(CF₃SO₂) (CF₃CO), R¹FBF₃ (where R¹F=n−CₘF₂ₘ₊₁, m=natural number of 1 to 4), and R²BF₃ (where R²=n−CₚH₂ₚ₊₁, p=natural number of 1 to 5). Furthermore, it is possible to use a metal salt obtained by mixing two or more kinds of these examples.

This embodiment employs the non-aqueous electrolytic solution as the electrolyte but may employ a solid electrolyte in the form of a gel or solid. That is to say, the electrolyte may be in any form such as liquid, cream, gel, and solid.

### (4) Other Elements

In addition to the aforementioned constituent elements, the secondary battery of this embodiment may include a structural member such as a separator and a battery case and also other elements required for a secondary battery. Those known in the related art are employable but the other elements preferably do not contain harmful substances or rare metals from the aspect of an environmental impact and disposal. Furthermore, these other elements are more preferably bio-based or biodegradable materials.

### (5) Method for Manufacturing Secondary Battery

As described above, the secondary battery of this embodiment includes at least the positive electrode, the negative electrode, and the non-aqueous electrolytic solution, and as illustrated in FIG. 1, the non-aqueous electrolytic solution is disposed between the positive electrode and the negative electrode, being in contact with the positive electrode and the negative electrode. The secondary battery having such a configuration is prepared in a manner similar to a secondary battery in the related art.

For example, the secondary battery may be obtained, according to a technique in the related art, by assembling the positive electrode containing the positive electrode redox mediator including the mqph-Ni complex and the positive electrode active material, the negative electrode containing magnesium (Mg), sodium (Na), or calcium (Ca), and the non-aqueous electrolytic solution to be in contact with the positive electrode and the negative electrode.

A method for manufacturing a secondary battery according to an embodiment enables manufacturing of, for example, a coin-type secondary battery.

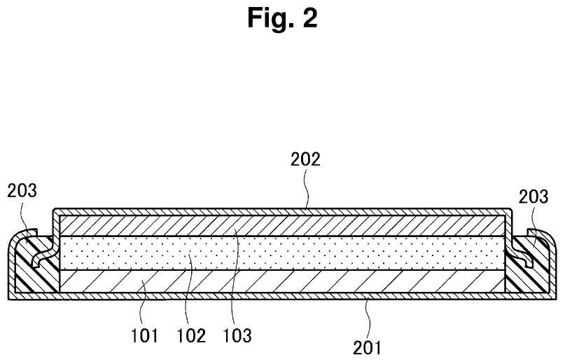

FIG. 2 is a schematic cross-sectional view illustrating a structure of a coin-type secondary battery. Specifically, first, a separator (not illustrated) is placed on a positive electrode case 201 where the positive electrode 101 is placed, and the electrolytic solution 102 is injected into the separator. Next, the negative electrode 103 is disposed on the electrolytic solution 102, and the positive electrode case 201 is covered with a negative electrode case 202. Next, peripheral portions of the positive electrode case 201 and the negative electrode case 202 are crimped with a coin cell crimping machine, thereby producing a coin-type secondary battery including a propylene gasket 203.

The illustrated coin-type secondary battery uses DMBQ as a positive electrode active material. Therefore, in this embodiment, it is possible to produce a sealed battery which is storable for a long period of time.

### EXAMPLES

Hereinafter, Examples of the secondary battery according to this embodiment will be described in detail. In each Example, three types of secondary batteries were produced using magnesium (Mg), sodium (Na), or calcium (Ca) for each negative electrode and a propylene carbonate solution containing Mg[N(SO₂CF₃)₂]₂, NaN(SO₂CF₃)₂, or Ca[N(SO₂CF₃)₂]₂ for each non-aqueous electrolytic solution. Note that the present invention is not limited to the following Examples and may be changed appropriately and implemented without changing the gist of the invention.

### Example 1

In Example 1, secondary batteries of the coin type (FIG. 2) were produced with the following procedure. As a positive electrode redox mediator, an mqph-Ni complex was used. A positive electrode active material was prepared using DMBQ pressed on a copper-containing porous current collector (copper mesh, CU-118016, The Nilaco Corporation). As a negative electrode active material, a magnesium (Mg) foil, a sodium (Na) foil, or a calcium (Ca) foil was used for each battery. A propylene carbonate solution containing 0.5 mol/L of Mg[N(SO₂CF₃)₂]₂, NaN(SO₂CF₃)₂, or Ca[N(SO₂CF₃)₂]₂ was used for each non-aqueous electrolytic solution.

### (Preparation of Redox Mediator)

At a molar ratio of 2:1:2,8-hydroxyquinoline (Sigma-Aldrich Co. LLC), o-phenyldiamine (Sigma-Aldrich Co. LLC), and sodium disulfate (FUJIFILM Wako Pure Chemical Corporation) were put in a flask, refluxed at 110° C. for one week, and washed with methanol, thereby obtaining mqph powder.

Next, the mqph powder, chromium (II) acetate, a dimer, and a monohydrate (available from Aldrich) were added to ethanol in the flask under a nitrogen atmosphere at room temperature to obtain equimolar amounts of mqph as a ligand and chromium as a central metal.

The obtained mqph powder and nickel (II) acetate tetrahydrate (available from Wako Pure Chemical Industries, Ltd.) were added to ethanol in the flask under a nitrogen atmosphere at room temperature to obtain equimolar amounts of mqph as a ligand and nickel as a central metal. This flask was rotated and heated with an evaporator to remove the solvent, thereby obtaining an mqph-Ni complex.

### (Preparation of Positive Electrode)

The obtained mqph-Ni complex powder, DMBQ powder (Sigma-Aldrich Co. LLC), Ketjen black powder (EC600JD, Lion Specialty Chemicals Co., Ltd.), and polytetrafluoroethylene (PTFE) powder were sufficiently pulverized and mixed with a mortar machine at a weight ratio of 40:40:10:10 and rolled, thereby producing a sheet-like electrode (thickness: 0.5 mm). This sheet-like electrode and the copper mesh current collector were cut into a circle having a diameter of 16 mm, and the circular sheet-like electrode was pressed on the circular copper mesh to obtain a positive electrode.

### (Preparation of Negative Electrode)

A magnesium (Mg) foil (thickness of 150 μm, The Nilaco Corporation), a sodium (Na) foil (thickness of 150 μm, Sigma-Aldrich Co. LLC), and a calcium (Ca) foil (thickness of 150 μm, The Nilaco Corporation) were cut into a circle having a diameter of 16 mm, and each foil was bonded to a copper foil (The Nilaco Corporation) with an ultrasonic welding machine.

### (Preparation of Secondary Battery)

The secondary batteries of the coin type illustrated in FIG. 2 were produced using coin battery cases (Hohsen Corp.).

A cellulose-based separator (Nippon Kodoshi Corporation) cut into a circle having a diameter of 18 mm was placed on each positive electrode case 201 provided with the positive electrode 101 prepared in the aforementioned method, and a propylene carbonate solution (Kishida Chemical Co., Ltd.) containing Mg[N(SO₂CF₃)₂]₂, NaN(SO₂CF₃)₂, or Ca[N(SO₂CF₃)₂12 was injected as the non-aqueous electrolytic solution 102 into each separator. The negative electrode 103 was placed on the non-aqueous electrolytic solution 102, the positive electrode case 201 was covered with the negative electrode case 202, and peripheral portions of the positive electrode case 201 and the negative electrode case 202 were crimped with a coin cell crimping machine, thereby obtaining a coin-type secondary battery including the propylene gasket 203.

### (Battery Performance)

The battery performance of each secondary battery prepared with the above procedure was measured. In battery cycle testing, a current was caused to flow at a current density of 1.0 mA/cm² per effective area of each positive electrode using a charge/discharge measurement system (available from Bio Logic), and a discharge voltage was measured until the battery voltage decreased from the open-circuit voltage to 0.10 V. Discharge testing of each battery was performed under a normal living environment. The discharge capacity is represented by a value (mAh/g) per unit weight of the positive electrode active material (DMBQ).

Table 1 shows the discharge capacity and the discharge voltage of each secondary battery in Example 1. As shown in Table 1, in Example 1, the discharge voltages of the batteries using magnesium (Mg), sodium (Na), or calcium (Ca) for the negative electrodes were 1.82 V, 2.08 V, and 2.05 V, respectively, and the discharge capacities were 92 mAh/g, 158 mAh/g, and 116 mAh/g, respectively. The discharge voltage herein is defined as a voltage when the charge capacity is one-half of the total charge capacity. As described above, each secondary battery in Example 1 was found to have excellent battery performance.

TABLE 1

| | Negative electrode | | | |
|---|---|---|---|---|
| Examples | active material | Mg | Na | Ca |
| Example 1 | Discharge voltage (V) | 1.82 | 2.08 | 2.05 |
| | Discharge capacity | 92 | 158 | 116 |
| | (mAh/g) | | | |
| Example 2 | Discharge voltage (V) | 1.96 | 2.18 | 2.11 |
| | Discharge capacity | 139 | 183 | 168 |
| | (mAh/g) | | | |
| Example 3 | Discharge voltage (V) | 2.00 | 2.29 | 2.22 |
| | Discharge capacity | 173 | 237 | 226 |
| | (mAh/g) | | | |
| Comparative | Discharge voltage (V) | 1.17 | 1.29 | 1.26 |
| Example 1 | Discharge capacity | 62 | 124 | 111 |
| | (mAh/g) | | | |

### Example 2

In Example 2, secondary batteries of the coin type were produced with the following procedure. In addition, mqph-Ni complex powder was used as a positive electrode redox mediator, DMBQ powder was used as a positive electrode active material, and these materials were supported on a non-woven fabric current collector (carbon felt) containing carbon. As a negative electrode active material, a magnesium (Mg) foil, a sodium (Na) foil, or a calcium (Ca) foil was used for each battery. A propylene carbonate solution containing 0.5 mol/L of Mg (ClO₄)₂, NaClO₄, or Ca(ClO₄)₂ was used for each non-aqueous electrolytic solution.

The batteries were evaluated in a manner similar to Example 1.

### (Preparation of Positive Electrode)

Carbon felt (Toyobo Co., Ltd.) was immersed in a liquid in which the mqph-Ni complex powder obtained with a procedure similar to Example 1 and DMBQ powder (Sigma-Aldrich Co. LLC) were dissolved in 1.0 M hydrochloric acid (Tokyo Chemical Industry Co., Ltd.). The carbon felt was dried in a vacuum dryer at 80° C. for 30 minutes to precipitate the mqph-Ni complex and DMBQ on the carbon felt, and then, washed with pure water. The carbon felt containing the mqph-Ni complex and DMBQ was cut into a circle having a diameter of 16 mm to obtain a positive electrode.

### (Preparation of Negative Electrode)

A magnesium (Mg) foil (thickness of 150 μm, The Nilaco Corporation), a sodium (Na) foil (thickness of 150 μm, Sigma-Aldrich Co. LLC), and a calcium (Ca) foil (thickness of 150 μm, The Nilaco Corporation) were cut into a circle having a diameter of 16 mm, and each foil was bonded to a copper foil (The Nilaco Corporation) with an ultrasonic welding machine.

### (Preparation of Secondary Battery)

The secondary batteries of the coin type illustrated in FIG. 2 were produced using coin battery cases (Hohsen Corp.).

A cellulose-based separator (Nippon Kodoshi Corporation) cut into a circle having a diameter of 18 mm was placed on each positive electrode case 201 provided with the positive electrode 101 prepared in the aforementioned method, and a propylene carbonate solution (Kishida Chemical Co., Ltd.) containing Mg(ClO₄)₂, NaClO₄, or Ca(ClO₄)₂ was injected as the non-aqueous electrolytic solution 102 into each separator. The negative electrode 103 was placed on the non-aqueous electrolytic solution 102, the positive electrode case 201 was covered with the negative electrode case 202, and peripheral portions of the positive electrode case 201 and the negative electrode case 202 were crimped with a coin cell crimping machine, thereby obtaining a coin-type secondary battery including the propylene gasket 203.

### (Battery Performance)

Table 1 shows the discharge capacity and the discharge voltage of each secondary battery in Example 2. As shown in Table 1, the battery using magnesium (Mg) for the negative electrode in Example 2 had a discharge capacity of 139 mAh/g, which was larger than the value of the corresponding battery in Example 1. The batteries in Example 2 using sodium (Na) or calcium (Ca) for the negative electrodes also had a discharge capacity larger than the value of the corresponding batteries in Example 1.

As shown in Table 1, the discharge voltages in Example 2 are larger than the discharge voltages in Example 1. That is to say, the overvoltage of each battery decreased more in Example 2 than in Example 1, and Example 2 achieved improvement in discharge energy efficiency.

These characteristics improvements are considered to be attributed to the use of the positive electrode formed by supporting the positive electrode active material on the carbon felt. Using such a positive electrode reduced the internal resistance of the battery and efficiently promoted battery reactions.

### Example 3

In Example 3, secondary batteries of the coin type were produced with the following procedure. In addition, mqph-Ni complex powder was used as a positive electrode redox mediator, DMBQ powder was used as a positive electrode active material, and these materials were supported on a monolith. As a negative electrode active material, a magnesium (Mg) foil, a sodium (Na) foil, or a calcium (Ca) foil was used for each battery. A propylene carbonate solution containing 0.5 mol/L of Mg[N(SO₂CF₃)₂]₂, NaN(SO₂CF₃)₂, or Ca[N(SO₂CF₃)₂12 was used for each non-aqueous electrolytic solution.

The batteries were evaluated in a manner similar to Example 1 and Example 2.

### (Preparation of Positive Electrode)

A monolith was immersed in a liquid in which the mqph-Ni complex powder obtained with a procedure similar to Example 1 and DMBQ powder (Sigma-Aldrich Co. LLC) were dissolved in 1.0 M hydrochloric acid (Tokyo Chemical Industry Co., Ltd.). The monolith was dried in a vacuum dryer at 80° C. for 30 minutes to precipitate the mqph-Ni complex and DMBQ on the monolith, and then, washed with pure water. The monolith containing the mqph-Ni complex and DMBQ was cut into a circle having a diameter of 16 mm to obtain a positive electrode.

In manufacturing the monolith, first, a bacterial cellulose gel produced by Acetobacter xylinum, an acetic acid bacterium, was placed in a test tube, and the test tube was immersed in liquid nitrogen for 30 minutes to completely freeze the bacterial cellulose gel. Next, the frozen bacterial cellulose gel was taken out into an eggplant flask and dried by a freeze dryer (Tokyo Rikakikai Co., Ltd.) in a vacuum having a pressure of 10 Pa or less. After that, the resultant was carbonized by being fired at 1200° C. for 2 hours under a nitrogen atmosphere, thereby manufacturing the monolith.

### (Preparation of Negative Electrode)

A magnesium (Mg) foil (thickness of 150 μm, The Nilaco Corporation), a sodium (Na) foil (thickness of 150 μm, Sigma-Aldrich Co. LLC), and a calcium (Ca) foil (thickness of 150 μm, The Nilaco Corporation) were cut into a circle having a diameter of 16 mm, and each foil was bonded to a copper foil (The Nilaco Corporation) with an ultrasonic welding machine.

### (Preparation of Secondary Battery)

The secondary batteries of the coin type illustrated in FIG. 2 were produced using coin battery cases (Hohsen Corp.).

A cellulose-based separator (Nippon Kodoshi Corporation) cut into a circle having a diameter of 18 mm was placed on each positive electrode case 201 provided with the positive electrode 101 prepared in the aforementioned method, and a propylene carbonate solution (Kishida Chemical Co., Ltd.) containing Mg [N(SO₂CF₃) 212, NaN(SO₂CF₃)₂, or Ca[N(SO₂CF₃)₂12 was injected as the non-aqueous electrolytic solution 102 into each separator. The negative electrode 103 was placed on the non-aqueous electrolytic solution 102, the positive electrode case 201 was covered with the negative electrode case 202, and peripheral portions of the positive electrode case 201 and the negative electrode case 202 were crimped with a coin cell crimping machine, thereby obtaining a coin-type secondary battery including the propylene gasket 203.

### (Battery Performance)

Table 1 shows the discharge capacity and the discharge voltage of each secondary battery in Example 3. As shown in Table 1, the battery using magnesium (Mg) for the negative electrode in Example 3 had a discharge capacity of 173 mAh/g, which was larger than the values of the corresponding batteries in Example 1 and Example 2. The batteries in Example 3 using sodium (Na) or calcium (Ca) for the negative electrodes also had a discharge capacity larger than the value of the corresponding batteries in Example 1 and Example 2.

As shown in Table 1, the discharge voltages in Example 3 are larger than the discharge voltages in Example 1 and Example 2. That is to say, the overvoltage of each battery decreased more in Example 3 than in Example 1 and Example 2, and Example 3 achieved improvement in discharge energy efficiency.

These characteristics s improvements are considered to be attributed to the use of the positive electrode formed by supporting the positive electrode active material on the monolith. Using such a positive electrode increased the loading of the positive electrode active material.

In addition, as shown in Table 2, the battery using magnesium (Mg) for the negative electrode in Example 3 had a discharge capacity of 174 mAh/g after 20 cycles, which was larger than the values of the corresponding batteries in Example 1 and Example 2. The batteries in Example 3 using sodium (Na) or calcium (Ca) for the negative electrodes also had a discharge capacity larger than the value of the corresponding batteries in Example 1 and Example 2.

TABLE 2

| | Negative electrode | | | |
|---|---|---|---|---|
| Examples | active material | Mg | Na | Ca |
| Example 1 | Discharge capacity after 20 | 72 | 136 | 96 |
| | cycles (mAh/g) | | | |
| Example 2 | Discharge capacity after 20 | 121 | 176 | 155 |
| | cycles (mAh/g) | | | |
| Example 3 | Discharge capacity after 20 | 174 | 232 | 214 |
| | cycles (mAh/g) | | | |
| Comparative | Discharge capacity after 20 | 19 | 31 | 30 |
| Example 1 | cycles (mAh/g) | | | |

These characteristics improvements are considered to be attributed to the use of the positive electrode formed by supporting the positive electrode active material on the monolith. Using such a positive electrode increased the loading of the positive electrode active material and also made it difficult for the positive electrode active material to be dissolved in the electrolytic solution by an electrochemical reaction.

### Comparative Example 1

In Comparative Example 1, secondary batteries of the coin type were produced with a procedure similar to Example 1 without using an mqph-Ni complex as a positive electrode redox mediator. The secondary batteries were evaluated with a procedure similar to Example 1.

To prepare a positive electrode, in Comparative Example 1, DMBQ powder (Sigma-Aldrich Co. LLC), Ketjen black powder (EC600JD, Lion Specialty Chemicals Co., Ltd.), and polytetrafluoroethylene (PTFE) powder were sufficiently pulverized and mixed with a mortar machine at a weight ratio of 80:10:10 and rolled, thereby producing a sheet-like electrode (thickness: 0.5 mm). This sheet-like electrode was cut into a circle having a diameter of 16 mm and pressed on a copper mesh to obtain a positive electrode. Other steps were similar to those in Example 1.

Table 1 shows the discharge capacity and the discharge voltage of each secondary battery in Comparative Example 1. As shown in Table 1, the discharge voltages of the batteries using magnesium (Mg), sodium (Na), or calcium (Ca) for the negative electrodes in Comparative Example 1 were 1.17 V, 1.29 V, and 1.26 V, respectively, and the discharge capacities were 62 mAh/g, 124 mAh/g, and 111 mAh/g, respectively. As shown in Table 2, the discharge capacities after 20 cycles were 19 mAh/g, 31 mAh/g, and 30 mAh/g, respectively.

In Comparative Example 1, the discharge voltages, the discharge capacities, and the discharge capacities after 20 cycles were lower than those in Examples 1 to 3. The improvements in discharge voltage, discharge capacity, and discharge capacity after 20 cycles in Examples 1 to 3 are considered to be attributed to the improvement in charge-discharge energy efficiency due to the positive electrode redox mediator that reduced the actual charge and discharge overvoltage.

Employing DMBQ for the positive electrode active material, magnesium, sodium, or calcium for the negative electrode active material, and a non-aqueous electrolytic solution for the electrolyte, the secondary battery of this embodiment is anticipated as a battery having a low environmental impact.

Furthermore, employing DMBQ for the positive electrode active material enables the secondary battery according to this embodiment to serve as a sealed battery that needs no air inlet unlike an air battery. Accordingly, the secondary battery of this embodiment is storable for a long period of time without causing volatilization of the electrolytic solution from an air inlet.

Therefore, the secondary battery of this embodiment is effectively used as a new drive source for various electronic devices such as small devices, sensors, and mobile devices.

Note that the present invention is not limited to the embodiment, and various modifications and combinations are possible within the technical idea of the present invention.

### REFERENCE SIGNS LIST

100 SECONDARY BATTERY
101 POSITIVE ELECTRODE
102 NON-AQUEOUS ELECTROLYTIC SOLUTION (ELECTROLYTE)
103 NEGATIVE ELECTRODE
201 POSITIVE ELECTRODE CASE
202 NEGATIVE ELECTRODE CASE
203 PROPYLENE GASKET

1. A secondary battery comprising:
a positive electrode containing an N,N′-mono-8-quinolyl-o-phenylene-Ni complex and 2,5-dimethoxy-1,4-benzoquinone;
a negative electrode containing magnesium, sodium, or calcium; and
an electrolyte disposed between the positive electrode and the negative electrode.

2. The secondary battery according to claim 1,
wherein the positive electrode is formed on a porous current collector containing at least one selected from the group consisting of aluminum, copper, and iron or on a non-woven fabric current collector containing carbon, and
the positive electrode does not contain a binder.

3. The secondary battery according to claim 1,
wherein the positive electrode is formed on a monolith having a three-dimensional network structure with a plurality of nanostructures being integrated, and
the positive electrode does not contain a binder.
